(19) United States
(12) Patent Application Publication
(10) Pub. No.: US 2010/0057891 A1
(43) Pub. Date: Mar. 4, 2010

(54) SYSTEM AND METHOD FOR PROVIDING INTERNET SERVICES BY A PORTAL DEVICE

(75) Inventor: I-Fei Tsai, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/256,439

(22) Filed: Oct. 22, 2008

(30) Foreign Application Priority Data
Sep. 1, 2008 (CN) 200810304332.3

(51) Int. Cl. G06F 15/177

(52) U.S. Cl. 709/220

(57) ABSTRACT

A method for providing Internet services by a portal device capable of electronically communicating with at least one user terminal over a communication medium is provided. The method includes connecting to at least one user terminal, detecting hardware capabilities of the at least one user terminal and saving the hardware capabilities as a configuration file for a first connection between the portal device and the at least one user terminal, receiving a service request indicating a service selected by the at least one user terminal, and executing the selected service dependent on the configuration file of the at least one user terminal and transmitting results to the at least one user terminal. A system providing the Internet services by the portal device is also provided.

### BACKGROUND

1. Field of the Invention

Embodiments of the present disclosure relate to systems and methods for providing Internet services, and more particularly to a system and method for providing Internet services via a portal device.

2. Description of related art

With increasing demands for wireless service, functions provided by mobile phones are continuously being developed, such as multimedia messages or streaming music. However, hardware capabilities of mobile phones require enhancement in order to perform complicated or resource consuming applications. For example, mobile phones with dual processors are used for multimedia applications, wherein one processor is responsible for an operating system and the other for compressing/decompressing multimedia data and corresponding computations. However, such dual processor structures are typically only available in expensive devices.

Concurrently, the data rate provided by network communication technologies has continuously increased, such that portal servers located in Internet Service Providers (ISPs) are capable of provide higher data rates for end users. Effective utilization of the increased bandwidth to simplify the required computations of the mobile devices requires further development.

Accordingly, a system and a method providing Internet services via a portal device are desirable in order to overcome the limitations described.

### SUMMARY

A method for providing Internet services by a portal device capable of electronically communicating with at least one user terminal over a communication medium is provided. The method includes connecting to at least one user terminal, detecting hardware capabilities of the at least one user terminal and saving the hardware capabilities as a configuration file for the first connection, receiving a service request indicating a service selected by the at least one user terminal, and executing the selected service dependent on the configuration file of the at least one user terminal and transmitting results to the at least one user terminal.

Other advantages and novel features of the present system and method for providing Internet services via a portal device will become more apparent from the following detailed description of preferred embodiments when taken in conjunction with the accompanying drawings.

### BRIEF DESCRIPTION OF THE DRAWINGS

FIG. 1 is a system view of an embodiment of a system for providing Internet services via a portal device;

FIG. 2 is a flowchart of a first embodiment of a method for providing Internet services via a portal device; and

FIG. 3 is a flowchart of a second embodiment of a method for providing Internet services via a portal device.

### DETAILED DESCRIPTION OF CERTAIN INVENTIVE EMBODIMENTS

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

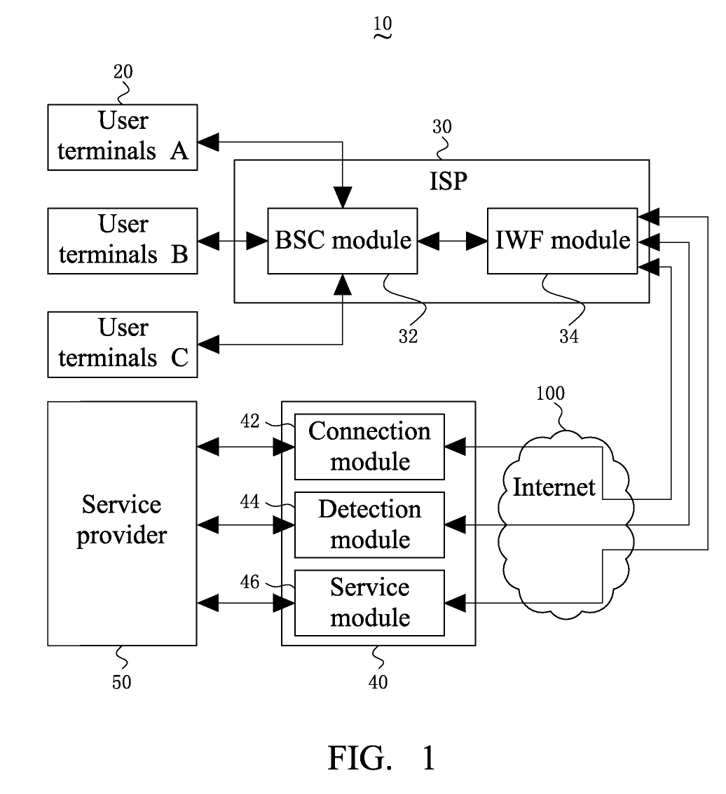

FIG. 1 is a system view illustrating an embodiment of a system 10 (the “system 10”) for providing Internet services, including at least one user terminal 20, an Internet Service Provider (ISP) 30, a portal device 40, and a service provider 50. The system 10, the ISP 30, the portal device 40, and the service provider 50 may all communicate over a communication medium, such as the Internet 100. The at least one user terminal 20 connects to the portal device 40 by the ISP 30 and initiates at least one user sessions on the portal device 40. The at least one user sessions may further connect to the service provider 50 to perform corresponding operations cooperatively with the service provider 50 to execute a certain service. The results of the operations executed on the portal device 40 are transmitted back to the at least one user terminal 20.

The at least one user terminal 20 is a thin client device, functionality of the at least one user terminals 20 being reduced to the point where, for the most part, only input and output capabilities are available. In an embodiment, the at least one user terminal 20 is a mobile phone including a wireless module, a processor, and a memory unit. Further, the at least one user terminal 20 may include electronic devices other than the mobile phone, such as notebook computers and personal digital assistants (PDAs), while remaining well within the scope of the disclosure.

The ISP 30 includes a base station control (BSC) module 32, and an Inter-Working Function (IWF) module 34. The BSC module 32 transmits and receives packets within service areas of the ISP 30, providing authentication, encryption, mobility management, and data transmission to/from the IWF module 34. The IWF module 34 provides routing between the BSC module 32 and other data networks. In the illustrated embodiment, the IWF module 34 connects the at least one user terminal 20 to the Internet 100.

The portal device 40 includes a connection module 42, a detection module 44, and a service module 46 for providing an operating environment to which the at least one user terminal 20 connects, and performs all standard computing operations traditionally associated with the user terminals 20. After, the portal device 40 transmits the computing results to the at least one user terminal 20.

The service provider 50 provides a plurality of Internet services indicated by a service menu. The Internet service includes Multimedia streaming and Unified Messaging Service (UMS). It is to be noted that while, in this embodiment, the UMS includes Short Message Services (SMS), Multimedia Message Services (MMS), Instant Message Services (IMS), and email, the disclosure is not limited thereto. The UMS, as an example is described further in detail below.

As shown in FIG. 1, the at least one user terminal 20 establishes connections with the portal device 40 via the ISP 30. Upon establishing the connection at the first time, the connection module 42 of the portal device 40 executes a registration procedure for the at least one user terminal 20. The registration procedure includes at least one forms (pop-up forms) for the at least one user terminal 20 to enter specific information. Such information typically will include Name, Address, Phone Numbers, Credit Card and/or Banking Information, Referral Information (if available), Personal Security information, and Preferred E-mail Identity.

After the registration procedure is completed, the detection module 44 of the portal device 40 detects the hardware capabilities of the at least one user terminal 20, such as speed of the CPU, wireless module type and capacities of the memory unit. The detection module 44 then stores the detection result as configuration files for each user terminal 20.

In addition, the connection module 42 also executes an authentication procedure when the at least one registered user terminal 20 connects thereto. Upon finishing the authentication procedure, the at least one user terminal 20 downloads the corresponding configuration files from the detection module 44 to initiate at least one user session on the portal device 40.

The at least one user terminal 20 may select an Internet service from a service menu downloaded from the service module 46 of the portal device 40. In this embodiment, the service menu may be downloaded from any of the service providers 50 connected to the portal device 40 in advance. In alternative embodiments, the service menu may be downloaded from the service provider 50 upon a service menu request received by the service provider 50.

After receiving the service menu, the at least one user terminal 20 sends a service request to the portal device 40. The service request defines the Internet service to be executed by the at least one user terminal 20. Upon receipt of the service request from the at least one user terminal 20, the service module 46 of the portal device 40 establishes connection with the service provider 50. In addition, the service module 46 also executes the selected service dependent on the configuration file of the at least one user terminal 20 retrieved from the detection module 44 and transmits the results to the at least one user terminal 20.

The at least one user terminal 20 also sets up preferences for each executed services, and the preferences are stored in the service module 46 of the portal device 40. In this way, the portal device 40 can directly load the corresponding preferences for the at least one user terminal 20 when the service is chosen again.

The at least one user terminal 20 sends a disconnection request to the portal device 40 to stop the executed service. Upon receipt of the disconnection request, the service module 46 of the portal device 40 forwards the disconnection request to the service provider 50 to break the connection between the portal device 40 and the service provider 50.

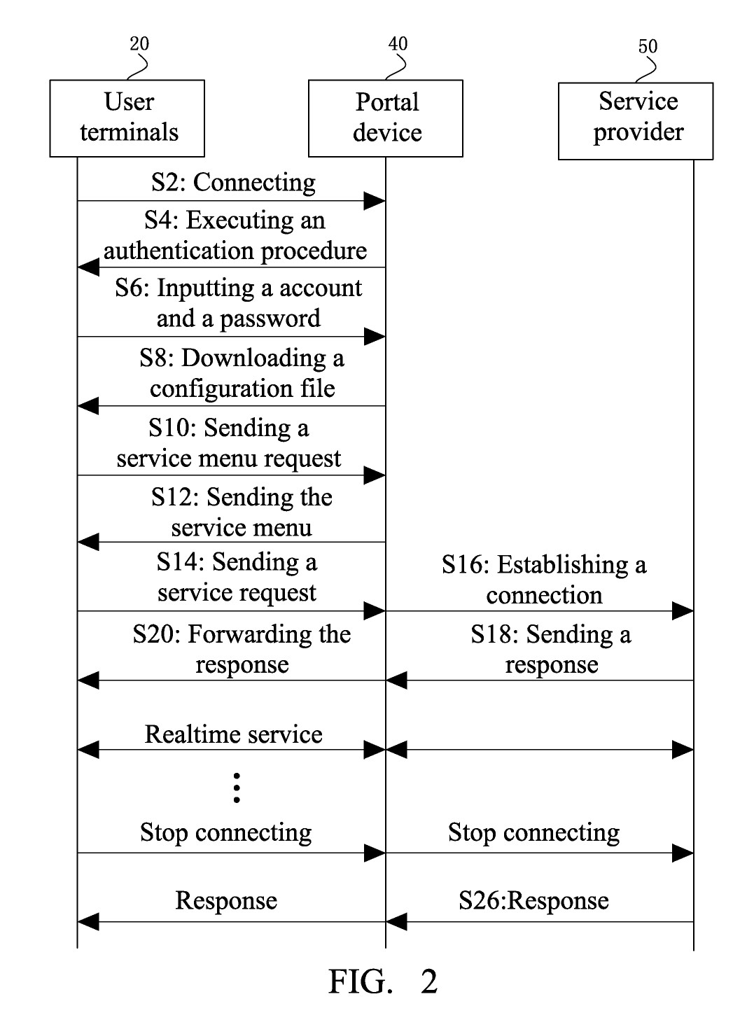

FIG. 2 is a flowchart of a first embodiment of a method for providing Internet services via a portal device. The method of FIG. 2 provides a computational service and transmits the computational results to the at least one user terminal 20. Alternatively, additional blocks may be added or deleted and the blocks may be executed in an order other than that described.

In block S2, the at least one user terminal 20 connects to the portal device 40. In block S4, the connection module 42 of the portal device 40 executes an authentication procedure for the at least one user terminal 20. In block S6, the at least one user terminal 20 inputs a account and a password in order to authenticate to the portal device 40.

After successful authentication, in block S8, the service module 46 of the portal device 40 loads a corresponding configuration file from the detection module 44 of the portal device 40 for the at least one user terminal 20. In block S10, the at least one user terminal 20 sends a service menu request to the portal device 40. In block S12, the service module 46sends the corresponding service menu to the at least one user terminal 20.

Upon receipt of the service menu, in block S14, the at least one user terminal 20 sends a service request, indicating a selected service, to the portal device 40.

Upon receipt of the service request, in block S16, the service module 46 of the portal device 40 establishes a connection with the service provider 50 providing the service. In block S18, the service provider 50 sends a response to the portal device 40. In block S20, the service module 46 of the portal device 40 forwards the response to the at least one user terminal 20. The service module 46 of the portal device 40 executes the selected service dependent on the configuration file of the at least one user terminal 20 retrieved from the detection module 44 and transmits the results to the at least one user terminal 20.

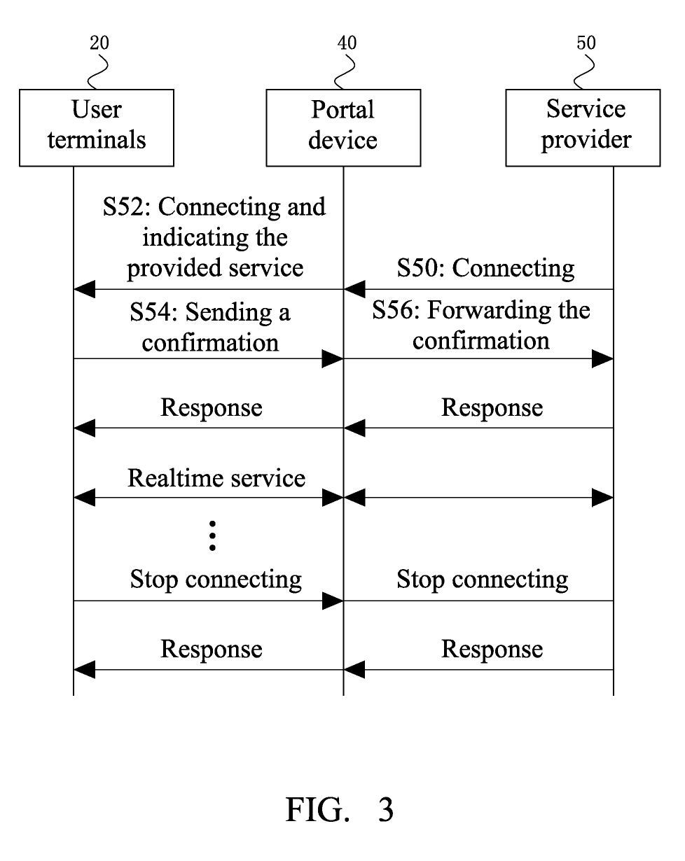

FIG. 3 is a flowchart of a second embodiment of a method for providing Internet services via a portal device, differing from the previous embodiment only in that the services are initiated by a service provider 50. The method of FIG. 3 may be used for providing complex or otherwise resource-consuming computational services initiated by the service provider 50, and transmitting the computational results to the at least one user terminal 20. Depending on the embodiment, additional blocks may be added or deleted and the blocks may be executed in an order other than that described.

In block S50, the service provider 50 connects to the portal device 40. In block S52, the service module 46 of the portal device 40 connects to the at least one user terminal 20 that are willing to accept services initiated by the service provider 50 and capable of receipt the provided services. In addition, the service module 46 of the portal device 40 notifies the at least one user terminal 20 of the provided service.

In block S54, the at least one user terminal 20 issues a confirmation to the portal device 40. In block S56, the service module 46 of the portal device 40 forwards the confirmation to the service provider 50. Upon receipt of the confirmation, the service provider 50 initiates services/contents to the at least one user terminal 20.

Understandably, in alternative embodiments, the functions performed by the portal device 40 and the service provider 50 may be incorporated to be performed by a single server.

It should be emphasized that the described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. A portal device capable of electronically communicating with at least one user terminal over a communication medium, the portal device comprising:
a detection module configured for detecting hardware capabilities of the at least one user terminal for a first connection between the portal device and the at least one user terminal and stores the hardware capabilities as a configuration file; and
a service module configured for executing a selected service from a service menu by the at least one user terminal dependent on the configuration file thereof, and transmitting results to the at least one user terminal.

2. The device as claimed in claim 1, wherein the service menu is downloaded from a service provider.

3. The device as claimed in claim 1, wherein the connection module is configured for executing an authentication procedure for the at least one user terminal upon establishing a connection between the portal device and the at least one user terminal.

4. The device as claimed in claim 3, wherein the service module is configured for loading the corresponding configuration file from the detection module for the at least one user terminal upon successful authentication of the at least one user terminal.

5. The device as claimed in claim 1, wherein the service module stores preferences for each executed services set up by the at least one user terminal.

6. The device as claimed in claim 1, wherein the at least one user terminal is a thin client device comprising a CPU, a memory unit, and a wireless module for establishing a connection to the portal device.

7. The device as claimed in claim 2, wherein the service module is configured for forwarding the service menu from the service provider to the at least one user terminal that are willing to accept services initiated by the service provider and capable of receiving the provided service.

8. A method for providing Internet services by a portal device capable of electronically communicating with at least one user terminal over a communication medium, the method comprising:
a connection step for connecting to at least one user terminal;
a detection step for detecting hardware capabilities of the at least one user terminal and saving the hardware capabilities as a configuration file for a first connection between the portal device and the at least one user terminal;
a service indication step for receiving a service request indicating a service selected by the at least one user terminal; and
a service execution step for executing the selected service dependent on the configuration file of the at least one user terminal and transmitting results to the at least one user terminal.

9. The method as claimed in claim 8, wherein the connection step further comprises:
executing an authentication procedure for the at least one user terminal;
establishing a connection upon successful authentication for the at least one user terminal; and
loading the corresponding configuration file for the at least one user terminal.

10. The method as claimed in claim 9, wherein the connection step further comprises:
receiving a service request from the at least one user terminal; and
forwarding a service menu to the at least one user terminal.

11. The method as claimed in claim 10, wherein the service indication step further comprises connecting to the service provider to perform corresponding operations cooperatively with the service provider.

12. The method as claimed in claim 8, wherein the service execution step further comprises saving preferences for each executed services set up by the at least one user terminal.

13. A method for providing Internet services by a portal device capable of electronically communicating with at least one user terminal over a communication medium, the method comprising:
a detection step for detecting hardware capabilities of the at least one user terminals connected to the portal device and storing the hardware capabilities as configuration files for a first connection between the portal device and the at least one user terminal;
a determination step for determining whether the at least one user terminal being capable of receiving a service initiated by a service provider dependent on the configuration file of the at least one user terminal; and
executing the service selected by the at least one user terminal dependent on the configuration file thereof and transmitting results to the at least one user terminal.

14. The method as claimed in claim 13, wherein the determination step further comprises:
determining whether the at least one user terminal is willing to accept the service in accordance with preferences set up by the at least one user terminal.

15. The method as claimed in claim 13, wherein the at least one user terminal is a thin client device comprising a CPU, a memory unit and a wireless module for establishing a connection.
